(19) United States
(12) Patent Application Publication
(10) Pub. No.: US 2013/0276559 A1
(43) Pub. Date: Oct. 24, 2013

(54) METHOD AND DEVICE FOR GENERATING A FORCE VECTOR

(71) Applicant: Kei International N.V., Bentveld (NL)

(72) Inventor: Aroon Johannus Siriphant, Hillegom (NL)

(21) Appl. No.: 13/918,493

(22) Filed: Jun. 14, 2013

Related U.S. Application Data
(63) Continuation of application No. 12/664,817, filed on Dec. 15, 2009, now abandoned.

(30) Foreign Application Priority Data
Jun. 15, 2007 (EP) 07110377.4

(51) Int. Cl. F03G 3/06

(52) U.S. Cl. CPC F03G 3/06
USPC 74/44

(57) ABSTRACT

Method for generating a force vector, comprising the steps of: providing at least a first mass and a second mass; making the first mass rotate around an axis of rotation; changing the distance between the first mass and the axis of rotation between two extreme positions while rotating the first mass; making the second mass move around an axis of rotation; changing the distance between the second mass and the axis of rotation between extreme positions while rotating the second mass; making the masses move in opposite direction with respect to each other; subjecting the masses to a deceleration phase and a subsequent acceleration phase while changing the direction of movement of said masses between the extreme positions; making each acceleration phase of said masses directly adjoin a subsequent decelerating phase.

### CROSS REFERENCE TO RELATED APPLICATIONS

This application is a continuation of U.S. application Ser. No. 12/664,817, filed Dec. 15, 2009 which is the national stage of PCT/NL2008/050382, filed Jun. 16, 2008, which claims priority to EP 07110377.4, filed Jun. 15, 2007, the contents of each of which are incorporated by reference herein.

### BACKGROUND OF THE INVENTION

The invention is related to a method for generating a force vector, comprising the steps of:
providing at least a first mass and a second mass,
making the first mass rotate around an axis of rotation,
changing the distance between the first mass and the axis of rotation between extreme positions while rotating the first mass around said axis of rotation,
making the second mass rotate around an axis of rotation,
changing the distance between the second mass and the axis of rotation between extreme positions while rotating the second mass around said axis of rotation,
making the masses move in opposite direction with respect to each other,
subjecting the masses to a deceleration phase and a subsequent acceleration phase while changing the direction of movement of said masses between the extreme positions.

Such a method is disclosed in U.S. Pat. No. 4,261,212. According to said United States patent, this method is carried out by means of a so-called unidirectional force generator, which may be used to propel a vehicle or other body in one direction. Also, this unidirectional force generator may serve to generate a force. According to an important aspect of this unidirectional force generator, masses are applied which are carried by endless chains or belts. These chains or belts move uniformly and continuously around two axes. Thereby, the distance of these masses with respect to a rotation centre is varied, whereby the unidirectional tierce is obtained upon rotating these masses in synchronism with the changing distances of these masses to the rotation centre.

When seen in axial direction with respect to the centre of rotation, the masses carried by the chains or belts are decelerated in axial direction as soon as the chains or belts in question are starting to turn around the axes near the locations of extreme positions with extreme distance to the rotation centre. After the masses have been decelerated to a velocity equal to zero in radial direction, they are accelerated in opposite direction. Subsequently, the chains or belts reach the straight part which extends towards the other axis, over which straight pan the masses are moving with a constant velocity, that is without being subjected to a deceleration or to an acceleration in radial direction.

As a result of the uniform movement of the chains or belts, the displacement of the masses with respect to the centre of rotation is thus generally of a constant velocity. This means that a certain amount of time is required in order to displace these masses between the extreme positions with respect to the centre of rotation. However, the speed of this radial mass displacement has a great influence on the effectiveness of the force generator. In general, a relatively long period of time for displacing the masses between the extreme positions, has a negative influence on the effectiveness.

### BRIEF SUMMARY OF THE INVENTION

The object of the invention is therefore to provide a method for generating a force vector which is more effective than the prior art method described before. Said object is achieved by the step of making each acceleration phase of said masses directly adjoin a subsequent decelerating phase.

According to the invention, the time period for travelling between the extreme positions of the masses with respect to the rotation centre is decreased by making the masses accelerate over the paths which stretch between these maximum and minimum distances. Similarly, after reaching a relatively high speed over these paths, the masses in question are subsequently decelerated. As a result of the acceleration and subsequent directly adjoining deceleration phases of the masses over these paths, a relatively short travelling time is obtained between the extreme positions. Thus, said masses can be brought very quickly in the desired maximum position over the part of the rotational paths thereof which provides the desired force vector, while at the same time they can be brought very quickly in the desired minimum position over the part of the rotational paths so as to detract as little as possible from the desired force vector.

The method according to the invention can be carried out in many different ways; for instance the masses can be rotated around separate rotational axes which are at a distance from each other. Preferably however, the method according to the invention comprises the step of making the axes of rotation of the first and second masses coincide. Furthermore, it is preferred that the masses move according to a path which intersects the axis of rotation. Most preferably, the masses move according to paths of similar shape. Also, it is preferred that the masses move according to paths of similar dimensions.

The desired way of displacing the masses between their extreme positions with respect to the axis of rotation by accelerating and decelerating thereof may be obtained in different ways as well. For instance, the masses may be displaced under the influence of explosive forces, such as obtained by igniting an explosive mixture of a fuel and air. This could be obtained by means of a radially extending pipe which comprises a floating piston connected to a mass, whereby to explosion chambers are present at both sides are of such floating piston/mass. Also, it is possible to apply an electric motor, e.g. a linear electric motor, and an appropriate electronic control device, for generating the desired movements and accelerations of the mass in question.

Preferably however, the method according to the invention comprises the step of making the masses move towards and from the axis of rotation by means of a crank/drive shaft mechanism. Such crank/drive shaft mechanism can be mechanically coupled the rotation drive of the drive system for making the masses rotate about the axis of rotation, whereby a well synchronised system is established. By means of the crank/drive shall mechanism, the masses can be guided over as guide member which extends radially with respect to the axis of rotation. Such guide member can for instance be carried out as an axially extending rod or a pair of axially extending rods over which mass members can slide. Although a mechanical synchronisation is possible, instead also other synchronisations may be applied, for instance electronically, hydraulically etc.

The invention is furthermore related to a device for generating a force vector by means of the method as described before. Said device comprises a main frame, at least two inertia units which are rotatably supported with respect to the main frame, as well as main drive means for rotating the inertia units, each inertia unit comprising a subframe and auxiliary drive means for displacing the masses with respect to the corresponding chide means between opposite extreme positions.

Such device is disclosed in U.S. Pat. No. 4,261,212 as well. According to the invention, the auxiliary drive means are carried out for subjecting the masses to at least one accelerating phase and at least one subsequent decelerating phase which directly adjoins the at least one accelerating phase.

The inertia units to be rotated with respect to the axis of rotation in several ways. For instance, the inertia units can each have a separate drive, which is synchronised with the auxiliary drive thereof. Preferably however, each inertia unit is provided with a respective driven gear wheel, which driven gear wheels are coaxial with respect to the common axis of rotation, a drive source being provided which is drivingly connected to a drive gear wheel the axis of rotation of which is perpendicular to the common axis of rotation, said drive gear wheel engaging both driven gear wheels. In this preferred embodiment, both inertia units are driven by a common single drive source.

According to a simple, reliable embodiment, the main frame comprises fixed auxiliary gear wheels and the inertia units each comprise a rotatable gear wheel engaging a respective fixed gear wheel of the main frame, a respective crank being connected to said rotatable gear wheels, a respective mass being drivingly connected to a corresponding crank by means of a drive shaft. In this way, the radial movement of the masses is directly synchronised with the rotational movements thereof. Preferably, each inertia unit comprises a guide member which extends radially with respect to the axis of rotation, each mass being supported displaceably by said guide means.

Alternatively, the main frame comprises fixed auxiliary gear wheels and the inertia units each comprise a rotatable gear wheel engaging a respective fixed gear wheel of the main frame, a respective crank being connected to said rotatable gear wheels, a respective mass connected to the free end of the crank.

With the aim of providing a steady, smooth force vector which lacks strong variations, preferably multiple sets of two inertia units each are provided. In this connection, these sets may have a common axis of rotation. Alternatively of course, such sets may have spaced, parallel axes of rotation.

An alternative way of carrying out the method according to the invention for generating, a force vector comprises the steps of:
providing at least a first mass and a second mass,
making the first mass rotate around an axis of rotation,
changing, the distance between the first mass and the axis of rotation between two extreme positions while rotating the first mass,
making the second mass rotate around an axis of rotation,
changing the distance between the second mass and the axis of rotation between extreme positions while rotating the second mass,
making the masses move in opposite direction with respect to each other
making the masses move towards and from the axis of rotation by means of a respective crank/drive shah mechanism.

An alternative device comprises the features of a main frame, at least two inertia units which are rotatably supported with respect to the main frame, as well as main drive means for rotating the inertia units, each inertia unit comprising a subframe, a mass and auxiliary drive means for displacing the masses between extreme positions, wherein the auxiliary drive means comprise a crank/drive shaft mechanism.

### BRIEF DESCRIPTION OF THE SEVERAL VIEWS OF THE DRAWINGS

The invention will now be further described with reference to an embodiment as shown in the drawings.

FIG. 1 shows a view in perspective of a device according to the invention.

FIG. 2 shows a top view of the device according to FIG. 1.

FIG. 3 shows a side view of the device according to FIG. 1.

FIG. 4 shows an end view of the device according to FIG. 1.

FIG. 5 shows a detail of a crank/drive shaft mechanism.

FIG. 6 shows a graph containing the path of the force vector.

FIGS. 7a-h show the force vector at different positions along the path of FIG. 6, divided in intervals of 45°.

FIG. 8 shows a graph giving several variables as a function of the rotation angle for a set of two interconnected inertia units.

FIG. 9 shows a graph giving the forces of four inertia units of the device according to FIG. 1 as a function of the rotation angle.

FIG. 10 shows a second embodiment of an alternative inertia unit.

### DETAILED DESCRIPTION OF THE INVENTION

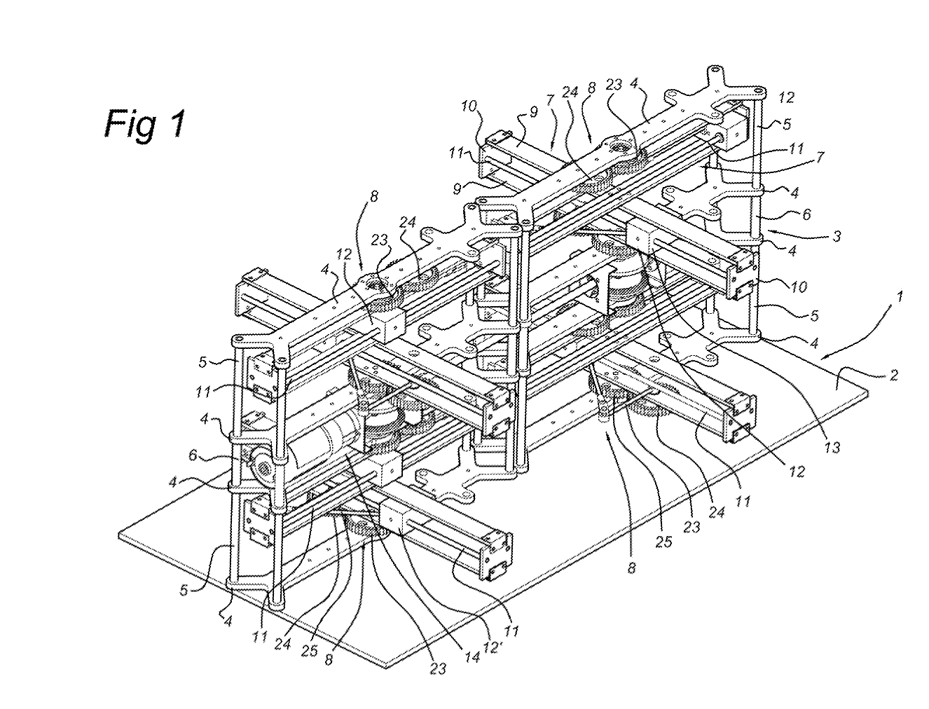

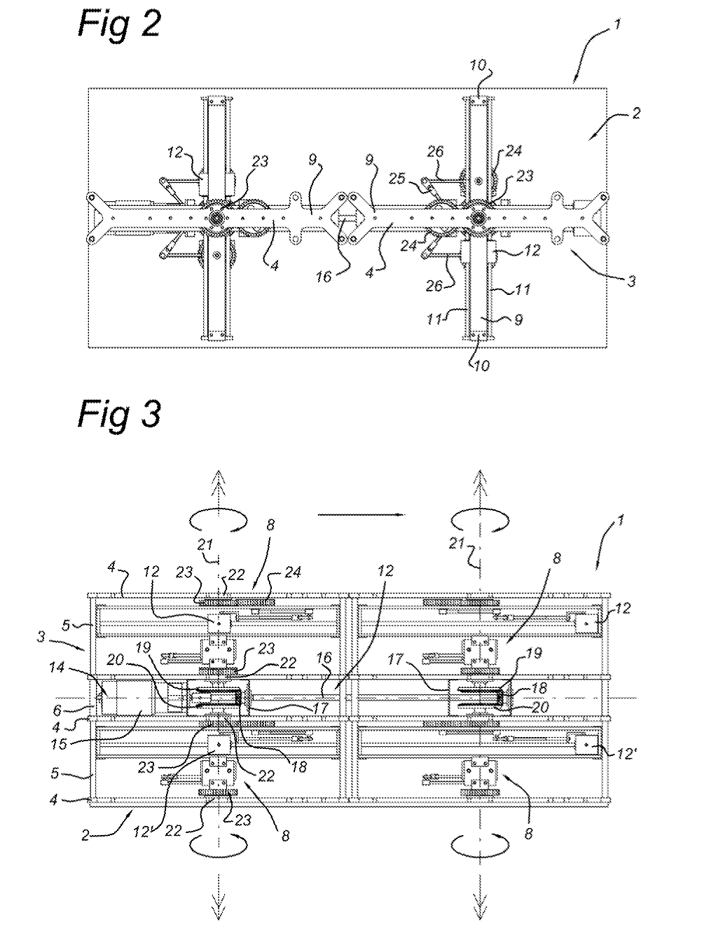

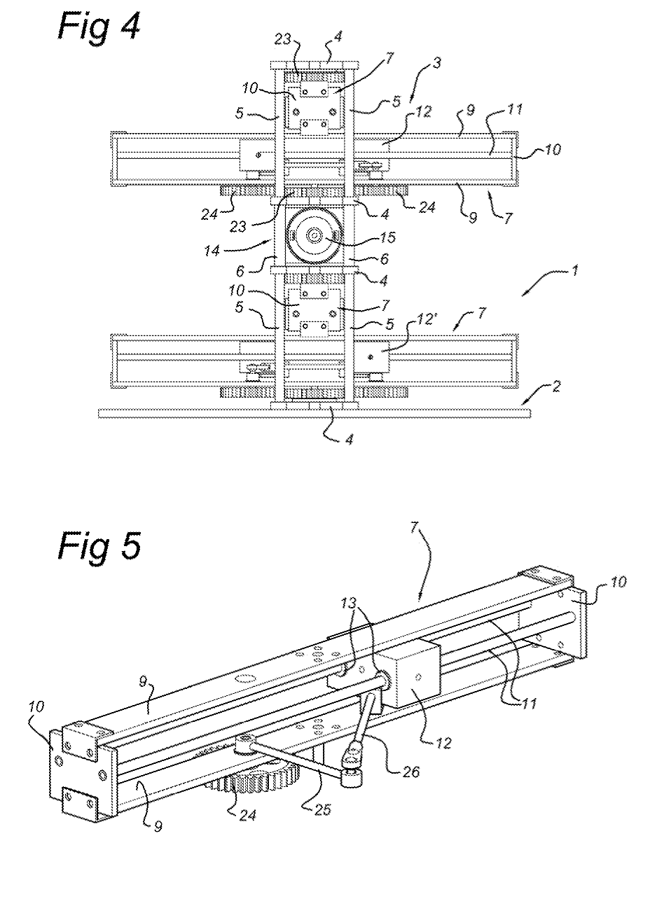

The device according to the invention as shown in FIG. 1 comprises a housing 1 provided with a base plate 2 and a frame structure 3 supported on the base plate 2. The main frame structure 3 consists of horizontal frame members 4 supported at a distance above each other by means of main columns 5 and auxiliary columns 6. Between each pair of horizontal frame members 4 and main columns 5, a set 8 consisting of two so-called inertia units 7 is rotatably supported. The inertia units 7 of each set 8 are interconnected as will be discussed below. Each inertia unit 7 consists, in the embodiment shown, of two parallel slats 9, which at the opposite ends are connected to each other by means of bulkheads 10. The bulkheads 10 carry each two shafts 11, over which shafts 11 a mass 12, 12′ is slidably guided. In this connection, each mass 12, 12′ comprises sliding bearings 13 for providing a smooth movement back and forth of the masses 12, 12′ with respect to the rods 11.

As shown in the figures, in each set 8 a lower slat 9 of an upper inertia unit 7 is connected to an upper slat 9 of a lower and inertia unit 7. Furthermore, the inertia units 7 of each set 8 are perpendicular only oriented with respect to each other having regard to the longitudinal extension of the rods 11 thereof. In the embodiment shown in FIG. 1, two of such sets 8 are superposed above each other by means of the auxiliary columns 6, the upper set comprising a mass 12, the lower set comprising a mass 12′. Between two of such sets 8, drive means 14 are accommodated. These drive means 14 consist of an electric motor 15 connected to as torsion drive shaft 16 supported with respect to the horizontal frame members 4 by means of supports 17. Onto the drive shaft 16, drive gear wheels 18 are mounted, which drive gear wheels 18 each engage an upper driven gear wheel 19 and a lower driven material 20. The upper driven gear wheel 19 is connected to the upper set 8 of inertia units 7, and similarly the lower driven gear wheel 20 is connected to the lower set 8 of inertia units 7. As a result of this layout, the upper set of inertia units 8 rotates in the opposite sense in comparison to the lower set of inertia units 8. The sets 8 of inertia units 7 are connected by means of bearings 22 to the horizontal frame members.

A fixed gear wheel 23 is connected to each horizontal frame member 4. In connection therewith a rotatable gear wheel 24 which engages the corresponding fixed gear wheel 23, is rotatably connected to each slat 9. As shown in the figures, and in particular in FIG. 5, a crank 25 is fixedly connected to the rotatable gear wheel 24. The crank 25 in turn is connected to the drive shaft 20, the other end of which is connected to the mass 12, 12′.

By energising the electric motor 15, the sets 8 of inertia units 7 are brought into rotation, whereby an upper set 8 rotates in opposite direction in comparison to a lower set 8. As a result of the rotational movements of the inertia units 7, the rotatable gear wheels 24 are brought into rotation whereby the crank 25/drive shaft 26 mechanism moves the masses 12, 12′ back and forth over the guide rods 11. Moreover, the masses 12, 12′ are accelerated over the part of their movement from the bulkhead 10 to the axis 21; subsequently and directly adjoining this accelerating phase, the mass is decelerated when moving from the axis 21 to the opposite bulkhead 10. Thereby, the efficiency of the device according to the invention is enhanced.

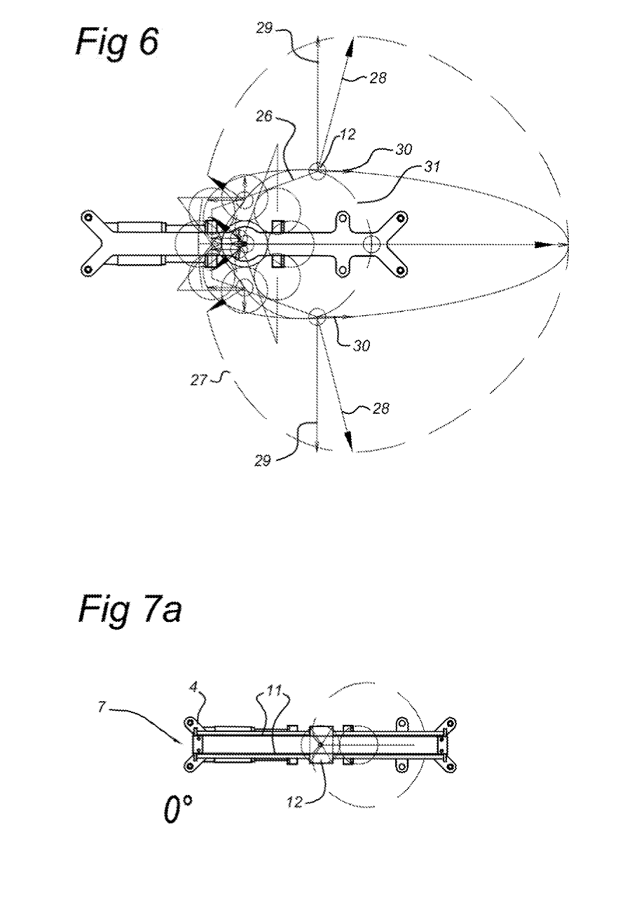

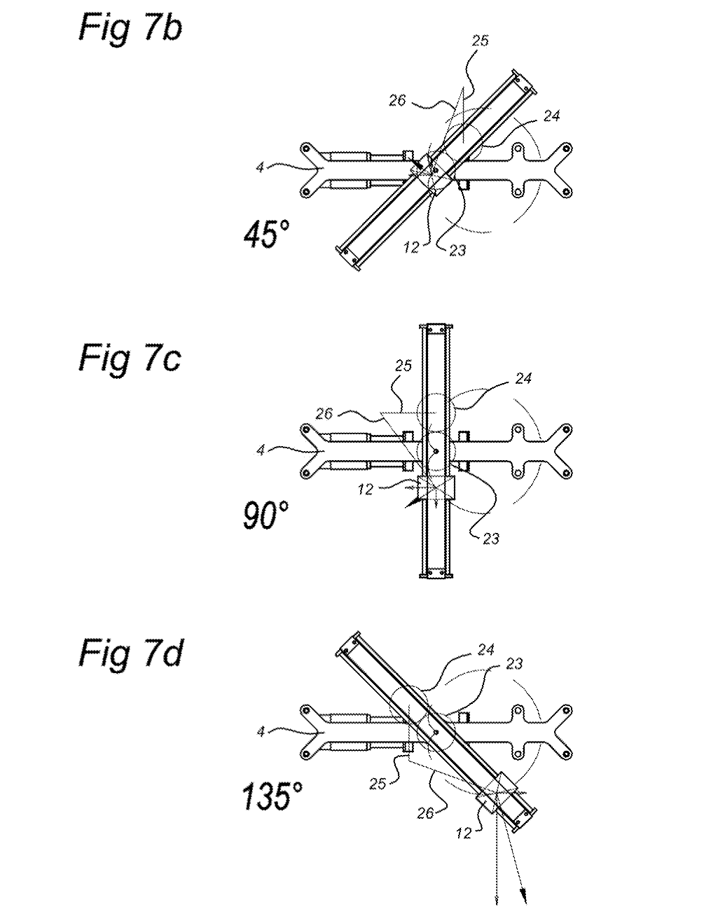

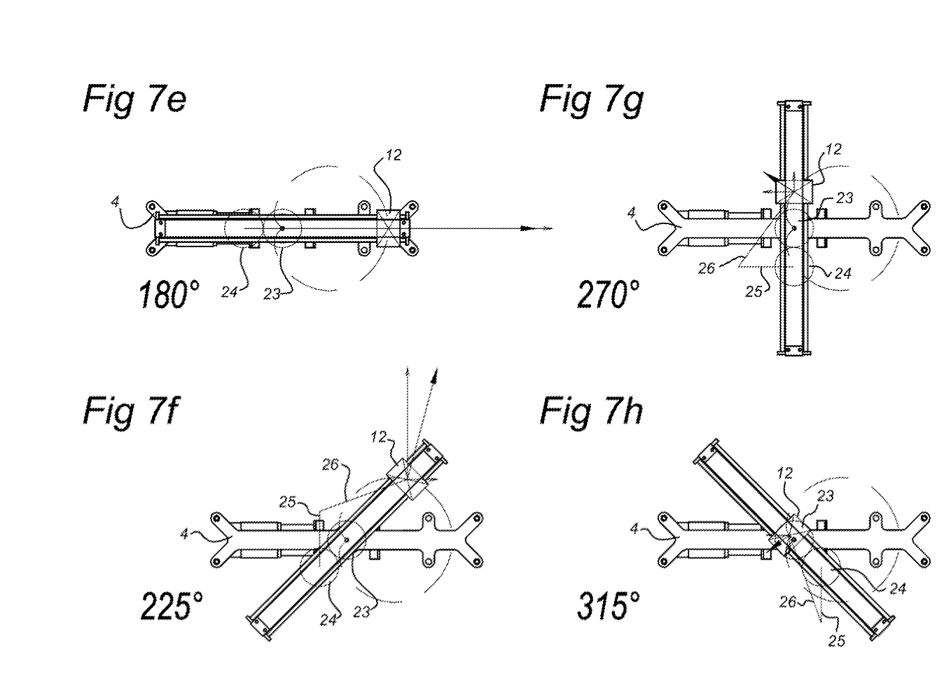

This increased efficiency is also clearly highlighted by the path of the force vector 28 of a single inertia unit 7 as shown in the FIGS. 6 and 7. This force vector 28 has a lateral component 29 and a longitudinal component 30. As this clear from the preceding description of the device according to the invention, each time a set 8 of two inertia units 7 is applied which rotate in opposite directions. This means that the lateral components 29 of the force vector 28 neutralize each other, while the longitudinal force component 30 of the force vector 28 are summarised. For clarity's sake, also the path 31 of the masses 12, 12′ corresponding to one of the inertia units is shown.

The FIGS. 7a-h furthermore highlight concrete points of the movement of the inertia unit 7 while rotating over a full location of 360°, by steps of 45°. It will be clear that initially at a rotation of 0°, the mass 12 is at the axis of rotation 21, and while moving to a rotation of 45° is only slightly displaced towards the right in FIG. 7b. After moving over the rotation of 90° as shown in FIG. 7c, the mass 12 has moved back in longitudinal direction to the position of 0° rotation. Subsequently, an accelerated and large movement occurs towards the rotation of 135°, whereas at a rotation of 180° velocity the longitudinal direction has become zero and the maximum distance from the axis of rotation 21 has been obtained.

Subsequently, an accelerated movement in longitudinal direction of the mass 12 occurs in the opposite direction. The movement of the mass 12 is decelerated while rotating to the 270° position shown in FIG. 7f and further while moving to the 315° position shown in FIG. 7g. When moving further past the 315° position shown in FIG. 7h, the longitudinal velocity of the mass has almost become zero, while the zero velocity is obtained at the 0° position shown in FIG. 7a.

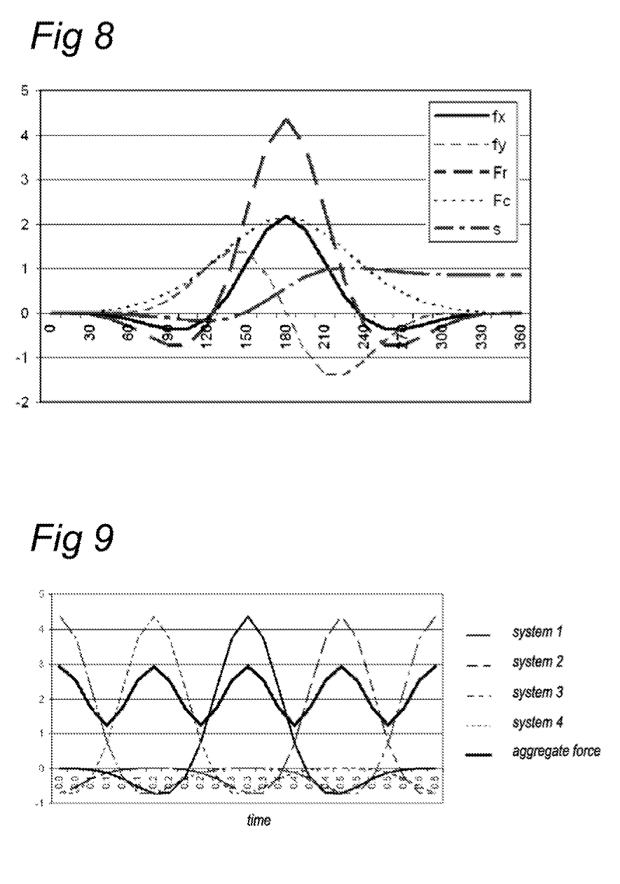

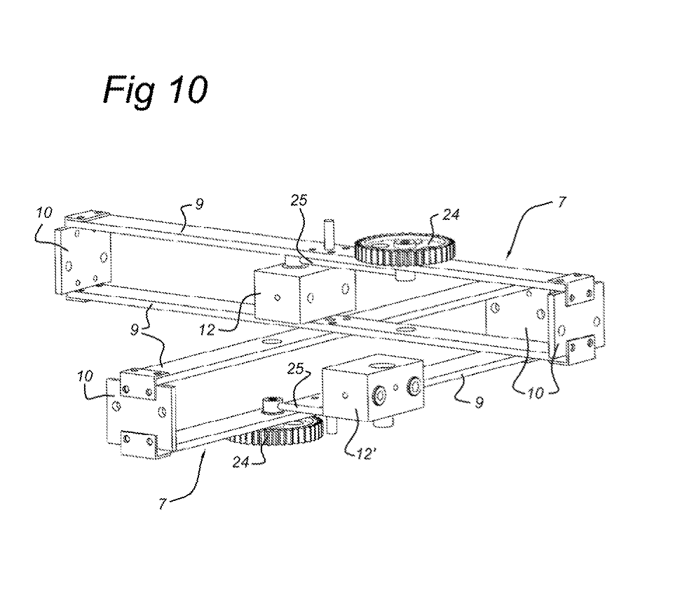

FIG. 8 shows several properties of a set of two inertia units 7, interconnected at right angles. The resulting driving force Fr has a predominant positive phase between 120-240 degrees, with only slightly negative phases between 1-120 degrees and 240-360 degrees. Furthermore, in FIG. 8 Fc represents the centrifugal force, fx represents the longitudinal force, fy represents the lateral force and S represents the distance travelled.

The method and device as described before can be applied for many different purposes. For instance, the application can be carried out for driving a ship without using a screw propeller, for driving a car without using a drive train between the engine and the wheels, of for propelling aircraft or spacecraft. In the latter case, a particular application may take the form of steering rockets.

Additionally, as a result of the possibility to omit may moving components in the examples described before, fuel consumption can be reduced through increased overall efficiency. An estimated 30% energy saving is possible.

### LIST OF REFERENCES

1. Housing

2. Base plate

3. Frame structure

4. Horizontal frame member

5. Main column

6. Auxiliary column

7. Inertia unit

8. Set of two inertia units

9. Slat

10. Bulk head

11. Rod

12, 12′ Mass

13. Sliding bearing

14. Drive means

15. Electric motor

16. Torsion drive shaft

17. Drive shaft support

18. Drive gear wheel

19. Upper driven gear wheel

20. Lower driven gear wheel

21. Rotation axis

22. Bearing

23. Fixed gear wheel

24. Rotatable gear wheel

25. Crank

26. Drive shaft

27. Force vector path

28. Force vector

29. Lateral force component

30. Longitudinal force component

31. Path of mass

What is claimed is:

1. A method for generating a force vector, comprising the steps of:
providing at least a first mass and a second mass;
making the first mass rotate around a first axis of rotation;
changing the distance between the first mass and the first axis of rotation between two extreme positions while rotating the first mass;
making the second mass rotate around a second axis of rotation;
changing the distance between the second mass and the second axis of rotation between extreme positions while rotating the second mass;
making the first mass and the second mass move in opposite directions with respect to each other; and
subjecting the first mass and the second mass to a deceleration phase and a subsequent acceleration phase while changing the direction of movement of the first mass and the second mass between the extreme positions;
making the acceleration phase of the first mass and the second mass directly adjoin a subsequent decelerating phase,
wherein the distance between the first mass and the first axis of rotation is changed using a first crank/drive shaft mechanism, and wherein the distance between the second mass and the second axis of rotation is changed using a second crank/drive shaft mechanism.

2. The method according to claim 1 wherein the first axis of rotation and the second axis of rotation coincide.

3. The method according to claim 1 wherein the first mass moves according to a path which intersects the first axis of rotation, and wherein the second mass moves according to a path which intersects the second axis of rotation.

4. The method according to claim 1 wherein the first mass moves according to a first path and the second mass moves according to a second path, the first path and the second path having a similar shape.

5. The method according to claim 1 wherein the first mass moves according to a first path and the second mass moves according to a second path, the first path and the second path having a similar dimension.

6. The method according to claim 1 wherein the distance between the first mass and the first axis of rotation is changed using a first crank, and wherein the distance between the second mass and the second axis of rotation is changed using a second crank.

7. The method according to claim 1 further comprising the steps of:
providing a drive source for making the first mass rotate around the first axis of rotation and the second mass rotate around the second axis of rotation; and
synchronizing the first crank/drive shaft mechanism and the second crank/drive shaft mechanism with the drive source.

8. The method according to claim 1, further comprising the steps of:
guiding the first mass over a first guide member which extends radially with respect to the first axis of rotation; and
guiding the second mass over a second guide member which extends radially with respect to the second axis of rotation.

9. A device for generating a force vector, the device comprising:
a main frame;
at least two inertia units, the inertia units rotatably supported with respect to the main frame; and
main drive means for rotating the at least two inertia units;
wherein each inertia unit comprises a subframe, a mass and an auxiliary drive means for displacing the mass between extreme positions, and wherein the auxiliary drive means is configured to subject the mass to at least one accelerating phase and at least one subsequent decelerating phase which directly adjoins the at least one accelerating phase,
wherein the main frame comprises a plurality of fixed auxiliary gear wheels, and wherein each inertia unit further comprises:
a rotatable gear wheel, the rotatable gear wheels each engaged with the respective fixed auxiliary gear wheel of the main frame; and
a crank, the crank connected to the rotatable gear wheel;
wherein the respective mass is drivingly connected to the respective crank by means of a drive shaft.

10. The device according to claim 9 wherein the main drive means is configured to rotate the subframes in opposite directions with respect to each other.

11. The device according to claim 9 further comprising guide means for guiding each mass, wherein each guide means intersects an axis of rotation of the respective mass.

12. The device according to claim 10 further comprising a drive source, wherein each inertia unit further comprises a driven gear wheel, the driven gear wheel coaxial w an axis of rotation of the respective mass, and wherein the drive source is drivingly connected to the drive gear wheel of each driven gear wheel, the drive source having an axis of rotation perpendicular to the axes or rotation of the masses.

13. The device according to claim 9 wherein each inertia unit further comprises a guide member which extends radially with respect to an axis of rotation of the mass, the mass supported displaceably by the guide member.

14. The device according to claim 9 wherein the main frame comprises a plurality of fixed auxiliary gear wheels, and wherein each inertia unit further comprises:
a rotatable gear wheel, the rotatable gear wheels each engaged with the respective fixed auxiliary gear wheel of the main frame; and
a crank, the crank connected to the rotatable gear wheel;
wherein the respective mass is connected to a free end of the crank.

15. The device according to claim 9 wherein the at least two inertia units comprise multiple sets of two inertia units.

16. The device according to claim 15 wherein the sets have a common axis of rotation.

17. The device according to claim 15 wherein the sets each have spaced, parallel axes of rotation.

18. A method for generating a force vector, comprising the steps of:
providing at least a first mass and a second mass;
making the first mass rotate around a first axis of rotation;
changing the distance between the first mass and the first axis of rotation between two extreme positions while rotating the first mass;
making the second mass rotate around a second axis of rotation;
changing the distance between the second mass and the second axis of rotation between extreme positions while rotating the second mass;
making the first mass and the second mass move in opposite directions with respect to each other; and
making the first mass and the second mass move towards and from then respective axes of rotation by means of respective crank/drive shaft mechanisms.

19. The method according to claim 18 wherein the first axis of rotation and the second axis of rotation coincide.

20. The method according to claim 18 wherein the fast mass moves according to a path which intersects the first axis of rotation, and wherein the second mass moves according to a path which intersects the second axis of rotation.

21. The method according to claim 18 wherein the first mass moves according to a first path and the second mass moves according to a second path, the first path and the second path having a similar shape.

22. The method according to claim 18 wherein the first mass moves according to a first path and the second mass moves according to a second path, the first path and the second path having a similar dimension.

23. The method according to claim 18 wherein the first mass and the second mass move towards and from their respective axes of rotation by means of respective cranks.

24. The method according to claim 18 further comprising the steps of:
providing a drive source for making the first mass rotate around the first axis of rotation and the second mass rotate around the second axis of rotation; and
synchronizing the respective crank/drive shaft mechanisms with the drive source.

25. The method according to claim 18, further comprising the steps of:
guiding the first mass over a first guide member which extends radially with respect to the first axis of rotation; and
guiding the second mass over a second guide member which extends radially with respect to the second axis of rotation.
